(19) United States
(12) Patent Application Publication
(10) Pub. No.: US 2012/0192200 A1
(43) Pub. Date: Jul. 26, 2012

(54) Load Balancing in Heterogeneous Computing Environments

(76) Inventors: Jayanth N. Rao, Folsom, CA (US); Eric C. Samson, Folsom, CA (US)

(21) Appl. No.: 13/094,449

(22) Filed: Apr. 26, 2011

Related U.S. Application Data
(60) Provisional application No. 61/434,947, filed on Jan. 21, 2011.

(51) Int. Cl. G06F 9/46

(52) U.S. Cl. 718/105

(57) ABSTRACT

Load balancing may be achieved in heterogeneous computing environments by first evaluating the operating environment and workload within that environment. Then, if energy usage is a constraint, energy usage per task for each device may be evaluated for the identified workload and operating environments. Work is scheduled on the device that maximizes the performance metric of the heterogeneous computing environment.

### CROSS-REFERENCE TO RELATED APPLICATION

This is a non-provisional application that claims priority from provisional application 61/434,947 filed Jan. 21, 2011, hereby expressly incorporated by reference herein.

### BACKGROUND

This relates generally to graphics processing and, particularly, to techniques for load balancing between central processing units and graphics processing units.

Many computing devices include both a central processing unit for general purposes and a graphics processing unit. The graphics processing units are devoted primarily to graphics purposes. The central processing unit does general tasks like running applications.

Load balancing may improve efficiency by switching tasks between different available devices within a system or network. Load balancing may also be used to reduce energy utilization.

A heterogeneous computing environment includes different types of processing or computing devices within the same system or network. Thus, a typical platform with both a central processing unit and a graphics processing unit is an example of a heterogeneous computing environment.

### BRIEF DESCRIPTION OF THE DRAWINGS

FIG. 1 is a flow chart for one embodiment;

FIG. 2 depicts plots for determining average energy per task; and

FIG. 3 is a hardware depiction for one embodiment.

### DETAILED DESCRIPTION

In a heterogeneous computing environment, like Open Computing Language (“OpenCL”), a given workload may be executed on any computing device in the computing environment. In some platforms, there are two such devices, a central processing unit (CPU) and a graphics processing unit (GPU). A heterogeneous-aware load balancer schedules the workload on the available processors so as to maximize the performance achievable within the electromechanical and design constraints.

However, even though a given workload may be executed on any computing device in the environment, each computing device has unique characteristics, so it may be best suited to perform a certain type of workload. Ideally, there is a perfect predictor of the workload characteristics and behavior so that a given workload can be scheduled on the processor that maximizes performance. But generally, an approximation to the performance predictor is the best that can be implemented in real time. The performance predictor may use both deterministic and statistical information about the workload (static and dynamic) and its operating environment (static and dynamic).

The operating environment evaluation considers processor capabilities matched to particular operating circumstances. For example, there may be platforms where the CPU is more capable than the GPU, or vice versa. However, in a given client platform the GPU may be more capable than the CPU for certain workloads.

The operating environment may have static characteristics. Examples of static characteristics include device type or class, operating frequency range, number and location of cores, samplers and the like, arithmetic bit precision, and electromechanical limits. Examples of dynamic device capabilities that determine dynamic operating environment characteristics include actual frequency and temperature margins, actual energy margins, actual number of idle cores, actual status of electromechanical characteristics and margins, and power policy choices, such as battery mode versus adaptive mode.

Certain floating point math/transcendental functions are emulated in the GPU. However, the CPU can natively support these functions for highest performance. This can also be determined at compile time.

Certain OpenCL algorithms use “shared local memory.” A GPU may have specialized hardware to support this memory model which may offset the usefulness of load balancing.

Any prior knowledge of the workload, including characteristics, such as how its size affects the actual performance, may be used to decide how useful load balancing can be. As another example, 64-bit support may not exist in older versions of a given GPU.

There may also be characteristics of the applications which clearly support or defeat the usefulness of load balancing. In image processing, GPUs with sampler hardware perform better than CPUs. In surface sharing with graphics application program interfaces (APIs), OpenCL allows surface sharing between Open Graphics Language (OpenGL) and DirectX. For such use cases, it may be preferable to use the GPU to avoid copying a surface from the video memory to the system memory.

The pre-emptiveness requirement of the workload may affect the usefulness of load balancing. For OpenCL to work in True-Vision Targa format bitmap graphics (IVB), the IVB OpenCL implementation must allow for preemption and continuing forward progress of OpenCL workloads on an IVB GPU.

An application attempting to micromanage specific hardware target balancing may defeat any opportunity for CPU/GPU load balancing if used unwisely.

Dynamic workload characterization refers to information that is gathered in real time about the workload. This includes long term history, short term history, past history, and current history. For example, the time to execute the previous task is an example of current history, whereas the average time for a new task to get processed can be either long term history or short terms history depending on the averaging interval or time constant. The time it took to execute a particular kernel previously is an example of past history. All of these methods can be effective predictors of future performance applicable to scheduling the next task.

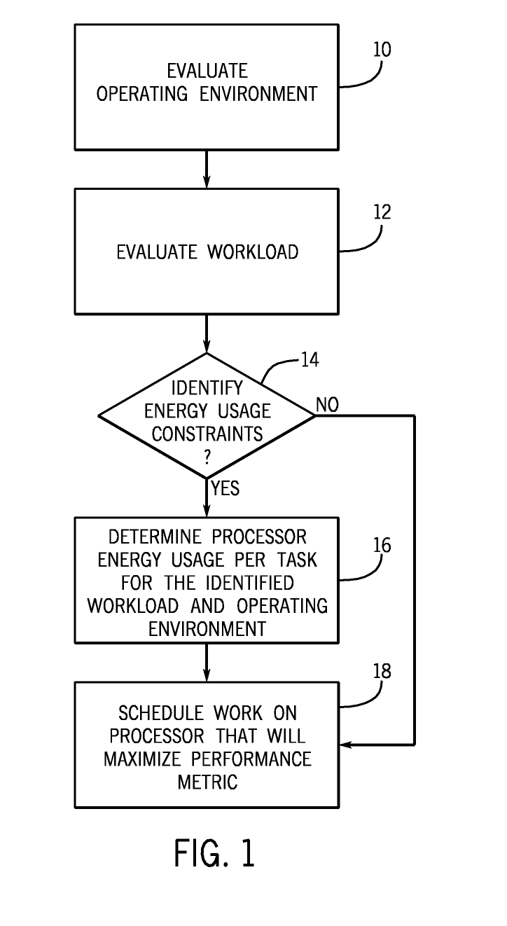

Referring to FIG. 1, a sequence for load balancing in accordance with some embodiments may be implemented in software, hardware, or firmware. It may be implemented by a software embodiment using a non-transitory computer readable medium to store the instructions. Examples of such a non-transitory computer readable medium include an optical, magnetic, or semiconductor storage device.

In some embodiments, the sequence can begin by evaluating the operating environment, as indicated at block 10. The operating environment may be important to determine static or dynamic device capability. Then, the system may evaluate the specific workload (block 12). Similarly, workload characteristics may be broadly classified as static or dynamic characteristics. Next, the system can determine whether or not there are any energy usage constraints, as indicated by block 14. The load balancing may be different in embodiments that must reduce energy usage than in those in which energy usage is not a concern.

Then the sequence may look at determining processor energy usage per task (block 16) for the identified workload and operating environment, if energy usage is, in fact, a constraint. Finally, in any case, work may be scheduled on the processor to maximize performance metrics, as indicated in block 18. If there are no energy usage constrains, then block 16 can simply be bypassed.

Target scheduling policies/algorithms may maximize any given metric, oftentimes summarized into a set of benchmark scores. Scheduling policies/algorithms may be designed based on both static characterization and dynamic characterization. Based on the static and dynamic characteristics, a metric is generated for each device, estimating its appropriateness for the workload scheduling. The device with the best score for a particular processor type is likely to be scheduled on that processor type.

Platforms may be maximum frequency limited, as opposed to being energy limited. Platforms which are not energy limited can implement a simpler form of the scheduling algorithms required for optimum performance under energy limited constraints. As long as there is energy margin, a version of the shortest schedule estimator can drive the scheduling/load balancing decision.

The knowledge that a workload will be executed in short, but sparsely spaced bursts, can drive the scheduling decision. For bursty workloads, a platform that would appear to be energy limited for a sustained workload will instead appear to be frequency limited. If we do not know ahead of time that a workload will be bursty, but we have an estimate of the likelihood that the workload will be bursty, that estimate can be used to drive the scheduling decision.

When power or energy efficiency is a constraint, a metric based on the processor energy to run a task can be used to drive the scheduling decision. The processor energy to run a task is:

$$Processor A energy to run next task = Power consume by processor A * Duration on processor A$$

$$Processor B energy to run next task = Power consumed by processor B * Duration on processor B$$

When the workload behavior is not known ahead of time, estimates of these quantities are needed. If the actual energy consumption is not directly available (from on-die energy counters, for example), then an estimate of the individual components of the energy consumption can be used instead. For example (and generalizing the equations for processor X),

$$Processor X energy to run next task \sim Power estimate for processor X * Estimated duration on processor X$$

$$Power\_estimate \_for \_processor X \sim static\_power \_estimate ( v , f , T ) + dynamic\_power \_estimate ( v , f , T , t ) ,$$

where static_power_estimate (v, f, T) is a value taking into account voltage v, normalized frequency f, and temperature T dependency, but not in a workload dependent real time updated manner. The Dynamic_power_estimate (v, f, T, t) does take workload dependent real time information t into account.

For example,

$$Dynamic\_power \_estimate ( v , f , T , n ) = ( 1 - b ) * Dynamic\_power \_estimate ( v , f , T , n - 1 ) + b * instantaneous\_power \_estimate ( v , f , T , n ) ,$$

where “b” is a constant used to control how far into the past to consider for the dynamic_power_estimate. Then,

$$instantaneous\_power \_estimate ( v , f , T , n ) = C\_estimate * v \hat{} 2 * f + I ( v , T ) * v ,$$

where C_estimate is a variable tracking the capacitive portion of the workload power and I (v, T) is tracking the leakage dependent portion of the workload power. Similarly, it is possible to make an estimate of the workload based on measurements of clock counts used for past and present workloads and processor frequency. The parameters defined in the equations above may be assigned values based on profiling data.

As an example of energy efficient self-biasing, a new task may be scheduled based on which processor type last finished a task. On average, a processor that quickly processes tasks becomes available more often. If there is no current information, a default initial processor may be used. Alternatively, the metrics generated for Processor A and Processor B may be used to assign work to the processor that finished last, as long as the processor that finished last energy to run task is less than:
G*Processor_that_did not
finish_last_energy_to_run_task,
   where “G” is a value determined to maximize overall performance.

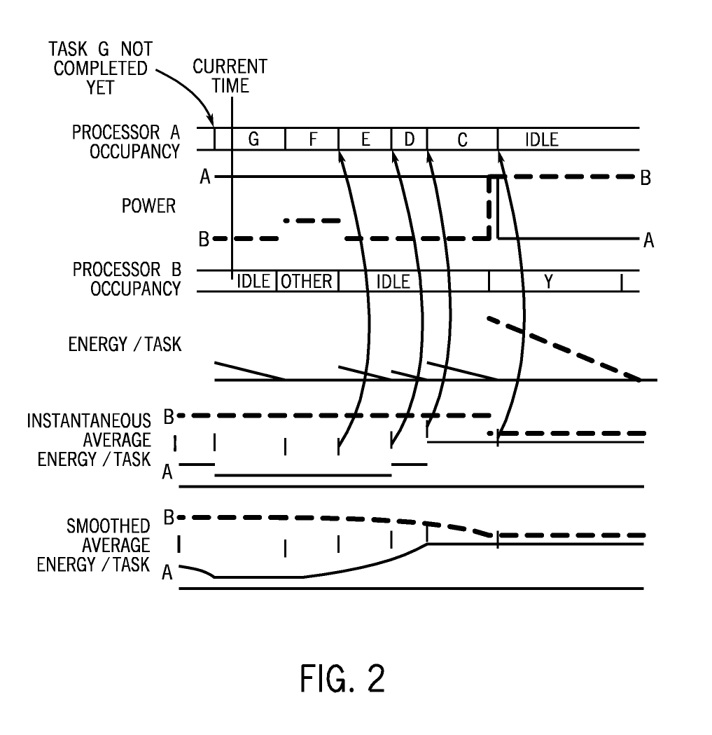

In FIG. 2, the horizontal axis shows the most recent events on the left side of the diagram, and the older events towards the right side. Then C, D, E, F, G, and Y are OpenCL tasks. Processor B runs some non-OpenCL task “Other,” and both processors experienced some periods of idleness. The next OpenCL task to be scheduled is task Z. All the processor A tasks are shown at equal power level, and also equal to processor B OpenCL task Y, to reduce the complexity of the example.

OpenCL task Y took a long time [FIG. 2, top] and hence consumed more energy [FIG. 2, lower down] relative to the other OpenCL tasks that ran on Processor A.

A new task is scheduled on the preferred processor until the time it takes for a new task to get processed on that processor exceeds a threshold, and then tasks are allocated to the other processor. If there is no current information, a default initial processor may be used. Alternatively, energy aware context work is assigned to the other processor if the time it takes for the preferred processor exceeds a threshold and the estimated energy cost of switching processors is reasonable.

A new task may be scheduled on the processor which has shortest average time for a new batch buffer to get processed. If there is no current information, a default initial processor may be used.

Additional permutations of these concepts are possible. There are many different types of estimators/predictors (Proportional Integral Differential (PID) controller, Kalman filter, etc.) which can be used instead. There are also many different ways of computing approximations to energy margin depending on the specifics of what is convenient on a particular implementation.

It is also possible to take into account additional implementation permutations by performance characterization and/or the metrics, such as shortest processing time, memory footprint, etc.

Metrics that can be used to adjust/modulate the policy decisions or decision thresholds to take into account energy efficiency or power budgets, including GPU and CPU utilization, frequency, energy consumption, efficiency and budget, GPU and CPU input/output (I/O) utilization, memory utilization, electromechanical status such as operating temperature and its optimal range, flops, and CPU and GPU utilization specific to OpenCL or other heterogeneous computing environment types.

For example, if we already know that processor A is currently I/O limited but that processor B is not, that fact can be used to reduce the task A projected energy efficiency running a new task, and hence decrease the likelihood that processor A would get selected.

A good load balancing implementation not only makes use of all the pertinent information about the workloads and the operating environment to maximize its performance, but can also change the characteristics of the operating environment.

In a turbo implemention, there is no guarantee that the turbo point for CPU and GPU will be energy efficient. The turbo design goal is peak performance for non-heterogenous non-concurrent CPU/GPU workloads. In the case of concurrent CPU/GPU workloads, the allocation of the available energy budget is not determined by any consideration of energy efficiency or end-user perceived benefit.

However, OpenCL is a workload type that can use both CPU and GPU concurrently and for which the end-user perceived benefit of the available power budget allocation is less ambiguous than other workload types.

For example, processor A may generally be the preferred processor for OpenCL tasks. However, processor A is running at its maximum operational frequency and yet there is still power budget. So processor B could also run OpenCL workloads concurrently. Then, it makes sense to use processor B concurrently in order to increase thruput (assuming processor B is able to get through the tasks quickly enough) as long as this did not reduce processor A's power budget enough to prevent it from running at its maximum frequency. The maximum performance would be obtained at the lowest processor B frequency (and/or number of cores) that did not impair processor A performance and yet still consumed the budget available, rather than the default operating system or PCU.exe choice for non-OpenCL workloads.

The scope of the algorithm can be further broadened. Certain characteristics of the task can be evaluated at compile time and also at execution time to derive a more accurate estimate of the time and resources required to execute the task. Setup time for OpenCL on the CPU and GPU is another example.

If a given task has to complete within a certain time limit, then multiple queues could be implemented with various priorities. The schedule would then prefer a task in higher priority queue over a lower priority queue.

In OpenCL inter-dependencies are known at execution by OpenCL event entities. This information may be used to ensure that inter-dependency latencies are minimized.

GPU tasks are typically scheduled for execution by creating a command buffer. The command buffer may contain multiple tasks based on dependencies for example. The number of tasks or sub-tasks may be submitted to the device based on the algorithm.

GPUs are typically used for rendering the graphics API tasks. The scheduler may account for any OpenCL or GPU tasks that risk affecting interactiveness or graphics visual experience (i.e, takes longer than a predetermined time to complete). Such tasks may be preempted when non-OpenCL or render workloads are also running.

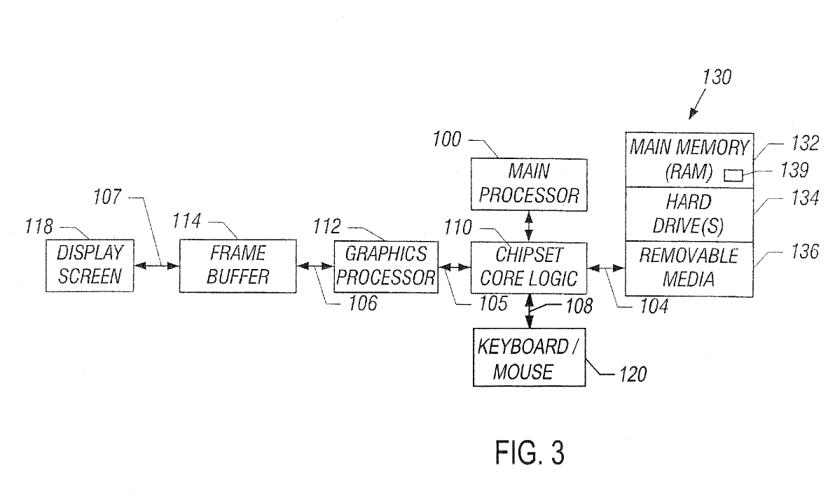

The computer system 130, shown in FIG. 3, may include a hard drive 134 and a removable medium 136, coupled by a bus 104 to a chipset core logic 110. The computer system may be any computer system, including a smart mobile device, such as a smart phone, tablet, or a mobile Internet device. A keyboard and mouse 120, or other conventional components, may be coupled to the chipset core logic via bus 108. The core logic may couple to the graphics processor 112, via a bus 105, and the main or host processor 100 in one embodiment. The graphics processor 112 may also be coupled by a bus 106 to a frame buffer 114. The frame buffer 114 may be coupled by a bus 107 to a display screen 118. In one embodiment, a graphics processor 112 may be a multi-threaded, multi-core parallel processor using single instruction multiple data (SIMD) architecture.

The processor selection algorithm may be implemented by one of the at least two processors being evaluated in one embodiment. In the case, where the selection is between graphics and central processors, the central processing unit may perform the selection in one embodiment. In other cases a specialized or dedicated processor may implement the selection algorithm.

In the case of a software implementation, the pertinent code may be stored in any suitable semiconductor, magnetic, or optical memory, including the main memory 132 or any available memory within the graphics processor. Thus, in one embodiment, the code to perform the sequences of FIG. 1 may be stored in a non-transitory machine or computer readable medium, such as the memory 132, and may be executed by the processor 100 or the graphics processor 112 in one embodiment.

FIG. 1 is a flow chart. In some embodiments, the sequences depicted in this flow chart may be implemented in hardware, software, or firmware. In a software embodiment, a non-transitory computer readable medium, such as a semiconductor memory, a magnetic memory, or an optical memory may be used to store instructions and may be executed by a processor to implement the sequence shown in FIG. 1.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
electronically choosing, between at least two processors, one processor to perform a workload based on the workload characteristics and the capabilities of the two processors.

2. The method of claim 1 including evaluating which processor has lower energy usage for the workload.

3. The method of claim 1 including choosing between graphics and central processing units.

4. The method of claim 1 including identifying energy usage constraints and choosing a processor to perform the workload based on the energy usage constraints.

5. The method of claim 1 including scheduling work on the processor that has a better performance metric for a given workload.

6. The method of claim 5 including evaluating the performance metric under static and dynamic workloads.

7. The method of claim 5 including selecting the processor that can perform the workload in the shortest time.

8. A non-transitory computer readable medium storing instructions for execution by a processor to:
allocate workloads between at least two processors, one processor to perform a workload based on the workload characteristics and the capabilities of the two or more processors.

9. The medium of claim 8 further storing instructions to evaluate which processor has lower energy usage for the workload.

10. The medium of claim 8 further storing instructions to choose between graphics and central processing units.

11. The medium of claim 8 further storing instructions to identify energy usage constraints and choose a processor to perform the workload based on the energy usage constraints.

12. The medium of claim 8 further storing instructions to schedule work on the processor that has a better performance metric for a given workload.

13. The medium of claim 12 further storing instructions to evaluate the performance metric under static and dynamic workloads.

14. The medium of claim 12 further storing instructions to select the processor that can perform the workload in the shortest time.

15. An apparatus comprising:
a graphics processing unit;
and
a central processing unit coupled to said graphics processing unit, said central processing unit to select a processor to perform a workload based on the workload characteristics and the capabilities of the two processors.

16. The apparatus of claim 15 said central processing unit to evaluate which processor has lower energy usage for the workload.

17. The apparatus of claim 15 said central processing unit to identify energy usage constraints and choose a processor to perform the workload based on the energy usage constraints.

18. The apparatus of claim 15 said central processing unit to schedule work on the processor that has a better performance metric for a given workload.

19. The apparatus of claim 18 said central processing unit to evaluate the performance metric under static and dynamic workloads.

20. The apparatus of claim 18 said central processing unit to select the processor that can perform the workload in the shortest time.
